(19) United States
(12) Patent Application Publication
(10) Pub. No.: US 2026/0325915 A1
(43) Pub. Date: Oct. 22, 2026

(54) REHABILITATION EXERCISE ERGOMETER ENABLING TILTING OF PEDAL TRACK

(71) Applicant: KOREA UNIVERSITY RESEARCH AND BUSINESS FOUNDATION, Seoul (KR)

(72) Inventors: Seonghyun KANG, Seoul (KR); Seung-Jong KIM, Seoul (KR); Seunghan PARK, Seoul (KR); Jae Woo CHO, Seoul (KR); Jaewook KIM, Seoul (KR)

(73) Assignee: KOREA UNIVERSITY RESEARCH AND BUSINESS FOUNDATION, Seoul (KR)

(21) Appl. No.: 19/100,583

(22) PCT Filed: Aug. 3, 2023
(86) PCT No.: PCT/KR2023/011378

§ 371 Date: Feb. 24, 2025

(30) Foreign Application Priority Data
Aug. 3, 2022 (KR) 10-2022-0096592

(51) Int. Cl. A63B 22/06; A63B 21/00; A63B 21/22; A63B 22/00; A63B 24/00

(52) U.S. Cl. CPC A63B 22/0605; A63B 21/225; A63B 21/4034; A63B 24/0087; A63B 2022/0094; A63B 2022/0611; A63B 2022/0641; A63B 2024/0068; A63B 2024/0093; A63B 2225/096

(57) ABSTRACT

Disclosed is rehabilitation exercise ergometer enabling tilting of a pedal track corresponding to the plane of rotation of a crank arm. The rehabilitation exercise ergometer according to an embodiment of the present invention comprises: a flywheel provided in a bicycle ergometer body so as to be rotatable; plane-of-rotation adjustment parts each provided at one of two sides of the flywheel; crank arms rotatably coupled to the plane-of-rotation adjustment parts; and pedal parts each provided at an end portion of the crank arm. The plane-of-rotation adjustment parts adjust the deflection angle of the rotational axis of the plane of rotation in which the crank arm rotates, such that the pedal track of the pedal part can tilt.

### TECHNICAL FIELD

The present disclosure relates to a rehabilitation exercise ergometer that is a bicycle ergometer device for a rehabilitation exercise that may help a rehabilitation exercise of a rehabilitation patient, and more particularly, to a rehabilitation exercise ergometer that enables tilting of a pedal track corresponding to a plane of rotation of a crack arm.

### BACKGROUND ART

Early ambulation is an important factor in an initial treatment of surgical rehabilitation patients. Rehabilitation exercises are very important for rehabilitation patients who require long-term non-weight bearing training, such as hip neck fractures, acetabular fractures, and tibial plateau fractures. As an element of rehabilitation of a lower body, it is recommended that joint range of motion exercises be performed immediately after surgery to prevent joint contractures, and muscle strength rehabilitation is necessary, so that it is necessary to perform rehabilitation training in the form of isotonic exercises in the early stages and gradually active and active assistive exercises.

With the development of precision measurement equipment, various preliminary studies have been conducted to change the muscle activation pattern, such as the position of the foot and the degree of rotation of each joint, when performing the existing rehabilitation exercise method, and based on this, theoretical developments are continuously being made to target the desired muscles and perform training depending on the change in the movement track or the relative position of each lower body joint, such as the ankle and knee joints, and to verify its effectiveness.

Musculoskeletal rehabilitation patients have different body structures, damaged portion, and degrees of damage, so the intensity of training, target muscles, and the like have to be tailored to each individual for an effective functional recovery. As an example, in the case of rehabilitation patients with hip fractures, which are increasing along with the prevalence of osteoporosis, the decline in gluteus medius function is evident, which can lead to abnormal gait, such as Trendelenburg gait, so training that targets the gluteus medius is essential.

In addition to the effectiveness of rehabilitation, the focus has to be on the stability of the rehabilitation patient, and in the early stages of surgery, the direction and degree of an external force has to be adjusted depending on the rehabilitation patient's situation to ensure the stability of the internal fixation device. As an example, in the case of rehabilitation patients who undergoes a hip joint replacement surgery, it is necessary to perform a control not to apply external forces in the direction of internal rotation to the hip joint, and in the case of fractures of the lateral tibial plateau, it is safer to adjust the direction of an external force to the medial side rather than to the lateral side of the tibia.

In a lower body rehabilitation, various medical devices are being utilized, from rehabilitation medical devices for bedside rehabilitation for early treatment of rehabilitation patients who cannot move, to exoskeleton suits that allow rehabilitation patients to be directly lifted to perform walking rehabilitation, but most of the existing devices are limited to the orbit of a rehabilitation exercise in the sagittal plane. Accordingly, muscles that play a major role in internal and external rotation and rotation, such as the gluteus medius and adductors, are often overlooked in early rehabilitation training, even though they play a very important role in daily life activities, such as walking. In particular, it is often difficult to perform exercises in the coronal plane due to pain and restrictions in movement, which requires them to be performed in a traumatic state.

In the case of the bicycle ergometer, it is highly utilized because it may adjust an exercise load without a precision drive system and has a structure that may assist rehabilitation movements by utilizing the power of the healthy side rather than the damaged portion, and recently, the combined rehabilitation effect of cognitive and physical functions is increasing through combination with augmented reality systems. In the bicycle ergometer, techniques have been studied to change the linear position of the crank arm and the pedal by changing the relative position of the pedal and the saddle, but the pedal rotation track depending on the plane of rotation of the crank arm has not been changed, so that the effect of the rehabilitation exercise is limited. The background technology described above is not mentioned as prior art, but should be understood to be only for explaining the background of the derivation of the present disclosure.

### DETAILED DESCRIPTION OF THE INVENTION

### Technical Problem

An aspect of the present disclosure provides a rehabilitation exercise ergometer that enables tilting of a pedal track corresponding to a plane of rotation of a crack arm.

An aspect of the present disclosure also provides a rehabilitation exercise ergometer that may maximize an effect of a rehabilitation exercise by determining a customized pedal track that suits a rehabilitation patient.

### Technical Solution

According to an aspect of the present disclosure, a rehabilitation exercise ergometer includes a flywheel provided in an ergometer of a bicycle to be rotatable, plane-of-rotation adjustment parts provided on opposite sides of the flywheel, respectively, crank arms coupled to the plane-of-rotation adjustment parts to be rotatable, and pedal parts provided at ends of the crank arms. The plane-of-rotation adjustment part may tilt a pedal track of the pedal part by adjusting a deflection angle of a rotation axis of a plane of rotation, on which the crank arm is rotated.

The plane-of-rotation adjustment part may switch the pedal track between a plurality of planes of rotation, in which the deflection angles of the rotational axis are different.

The plurality of planes of rotation may include a sagittal plane of rotation, in which the deflection angle of the rotation axis is parallel to a horizontal direction, a plane of internal rotation, in which the deflection angle of the rotation axis is tilted in a first direction with respect to the sagittal plane, and a plane of external rotation, in which the deflection angle of the rotational axis is tilted in a second direction being opposite to the first direction with respect to the sagittal plane.

The plane-of-rotation adjustment part may include a shaft seam connecting one end of the crank arm and the flywheel such that rotation of the crank arm is maintained at the same speed even when the plane of rotation of the crank arm is switched, and a shaft fixing part that fixes the crank arm in a state, a tilt angle is applied to the plane of rotation of the crank arm with respect to the plane of rotation of the flywheel.

The shaft fixing part may include a central member fixed to a body supporting the flywheel, an adjustment member coupled to an end of the crank arm to be rotatable about an angle adjustment axis, and a fixing member coupling the central member and the adjustment member. The central member may include a plurality of first coupling holes punched at every specific angle with respect to the angle adjustment axis, and forming an arc-shaped arrangement.

The adjustment member may include a second coupling hole at a position corresponding to the first coupling hole. The fixing member may include a ball lock pin inserted into at least one of the plurality of first coupling holes and the second coupling hole to fix the central member and the adjustment member.

The pedal part may include a pedal shaft coupled to an end of the crank arm to be rotatable in a direction being perpendicular to the crank arm, a pedal joint part connected to the pedal shaft by the joint fixing part, and that is rotatable in transverse axis and vertical axis directions, and a pedal footplate configured such that a relative angle to the pedal shaft is adjusted by the pedal joint part.

The pedal joint part may include a ball joint provided in the pedal joint body. The ball joint may include a ball joint mount holder provided in the pedal joint body and contacting a normal plane provided in an interior of the pedal joint body, and a fixing bolt inserted into the pedal joint body to raise the ball joint mount holder along the normal plane and fix the ball joint mount holder.

In an embodiment of the present disclosure, the shaft fixing part may further include a driver that adjusts a tilt angle of the rotation track of the pedal part by rotating the adjustment member with respect to the central member.

The rehabilitation exercise ergometer according to an embodiment of the present disclosure may further include a data collector that collects rehabilitation patient information including image information and body function information related to a rehabilitation patient, and rehabilitation-related information, a plane-of-rotation selector that determines a target plane of rotation for a rehabilitation exercise of the rehabilitation patient based on the rehabilitation patient information, and a controller that adjusts the plane of rotation by controlling the driver depending on the target plane of rotation.

The rehabilitation exercise ergometer according to an embodiment of the present disclosure may further include a measurement sensor that collects exercise information and biometric information related to the rehabilitation exercise of the rehabilitation patient during an exercise of the rehabilitation patient by the rehabilitation exercise ergometer, and an exercise performance evaluator that evaluates performance of the exercise of the rehabilitation patient depending on the plane of rotation based on the exercise information and the biometric information of the rehabilitation patient.

The rehabilitation exercise ergometer according to an embodiment of the present disclosure may further include a rotation track adjusting device that deforms a rotation track, in which the pedal part is rotated by the crank arm, into an elliptical form.

The crank arm may include a first crank arm body, and a second crank arm body coupled to the first crank arm body to be rotatable. The rotation track adjusting device may include a crank arm length adjusting device that adjusts a length of the crank arm body depending on a rotation cycle.

The crank arm length adjusting device may include a first gear member coupled to one end of the first crank arm body, a second gear member having a diameter being smaller than that of the first gear member, and coupled to the second crank arm body at an opposite end of the first crank arm body, and a ring-shaped belt member coupled to the first gear member and the second gear member.

The crank arm length adjusting device may be designed such that the second crank arm body is disposed in an upward/downward direction to overlap the first crank arm body when the first crank arm body is disposed in the upward/downward direction, and the second crank arm body is disposed to be spread out in parallel to an outside of the first crank arm body when the first crank arm body is disposed in a horizontal direction.

### Advantageous Effects of the Invention

According to an embodiment, the rehabilitation exercise ergometer that enables tilting of the pedal track corresponding to the plane of rotation of the crack arm is provided.

According to an embodiment of the present disclosure, by adjusting the deflection angle of the rotational axis of the crank arm, the plane of rotation may be changed, and by changing the posture of the foot part through tilting of the pedal, specific target muscles of the rehabilitation patient may be precisely targeted and trained, and by adjusting the direction of the load applied to each joint, pain caused by the rehabilitation exercise may be reduced and damaged portions may be protected.

According to an embodiment of the present disclosure, an individual user may perform effective training by focusing on the muscles and functions they want to train, and the stability of the exercise, such as relief of pain and protection of a surgical portion, by switching the direction of the external force applied to the joint.

In addition, according to an embodiment of the present disclosure, a customized pedal track that suits the rehabilitation patient may be determined to maximize the effect of the rehabilitation exercise using the ergometer.

In addition, according to an embodiment of the present disclosure, by changing the rotation track into an elliptical shape, the range of motion of the subject's joints may be expanded/diversified, compared to a circular rotation method, thereby increasing the effect of rehabilitation.

### DESCRIPTION OF THE DRAWINGS

FIG. 1 is a perspective view illustrating a rehabilitation exercise ergometer according to an embodiment of the present disclosure.

FIG. 2 is a plan view illustrating a rehabilitation exercise ergometer according to an embodiment of the present disclosure.

FIG. 3 is an enlarged plan view illustrating portion ‘A’of FIG. 1.

FIG. 4 is an enlarged perspective view illustrating portion ‘B’of FIG. 1.

FIG. 5 is a plan view illustrating an operation of a pedal part that constitutes a rehabilitation exercise ergometer according to an embodiment of the present disclosure.

FIG. 6 is a side view illustrating an operation of a pedal part that constitutes a rehabilitation exercise ergometer according to an embodiment of the present disclosure.

FIG. 7 is a cutaway perspective view illustrating a main part of a rehabilitation exercise ergometer according to an embodiment of the present disclosure.

FIGS. 8 to 10 are front views illustrating an operation of a rehabilitation exercise ergometer according to an embodiment of the present disclosure.

FIGS. 11 to 13 are perspective views illustrating an operation of a rehabilitation exercise ergometer according to an embodiment of the present disclosure.

FIG. 14 is a schematic diagram of a rehabilitation exercise ergometer according to an embodiment of the present disclosure.

FIG. 15 is a conceptual view illustrating a function of a rehabilitation exercise ergometer according to an embodiment of the present disclosure.

FIG. 16 is a perspective view illustrating a rehabilitation exercise ergometer according to another embodiment of the present disclosure.

FIG. 17 is a perspective view illustrating an operation of a rehabilitation exercise ergometer according to an embodiment of FIG. 16.

### BEST MODE

The above and other aspects, features and advantages of the present disclosure will become apparent from embodiments to be described in detail in conjunction with the accompanying drawings. However, the present disclosure is not limited to the embodiments disclosed below, but may be implemented in various forms. The embodiments of the present disclosure is provided to make the disclosure of the present disclosure complete and fully inform those skilled in the art to which the present disclosure pertains of the scope of the present disclosure. The same reference numerals denote the same elements throughout the specification.

A rehabilitation exercise ergometer according to an embodiment of the present disclosure includes a flywheel that is provided in an ergometer of a bicycle to be rotatable, plane-of-rotation adjustment parts that are provided on opposite sides of the flywheel, respectively, crank arms that are coupled to the plane-of-rotation adjustment parts to be rotatable, and pedal parts provided at ends of the crank arms, and the plane-of-rotation adjustment part is configured to tilt a pedal track of the pedal part by adjusting a deflection angle of a rotation axis of a plane of rotation, on which the crank arm is rotated. Accordingly, it is possible to precisely target and train a specific target muscle of the rehabilitation patient through tilting of the pedal track, and to mitigate pain caused by the rehabilitation exercise by adjusting directions of loads applied to respective joints, and to protect a damaged portion.

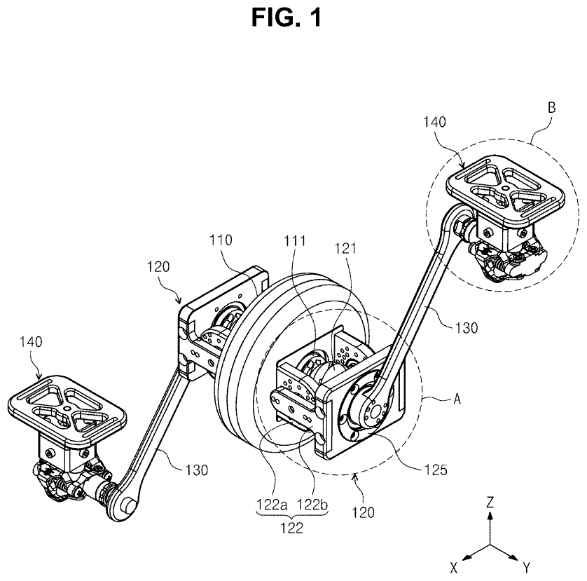

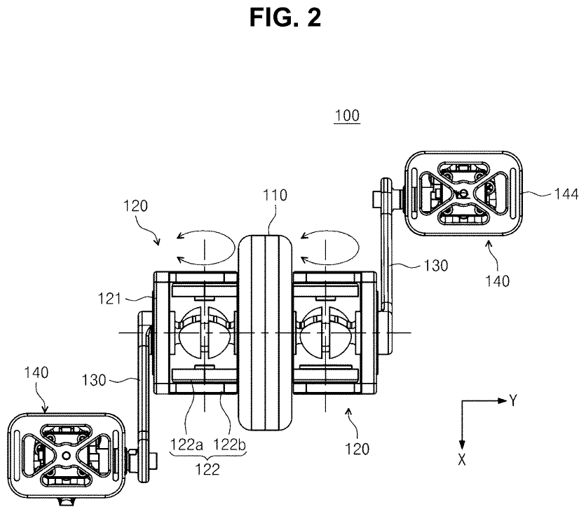

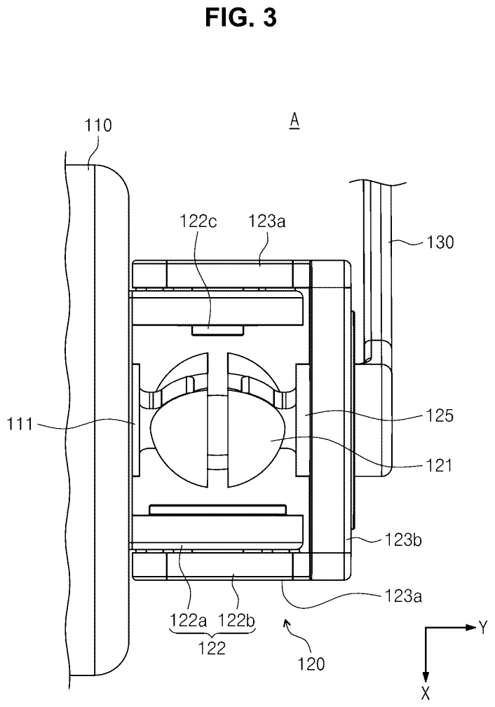

FIG. 1 is a perspective view illustrating a rehabilitation exercise ergometer according to an embodiment of the present disclosure. FIG. 2 is a plan view illustrating a rehabilitation exercise ergometer according to an embodiment of the present disclosure. FIG. 3 is an enlarged plan view illustrating portion ‘A’ of FIG. 1. Referring to FIGS. 1 to 3, a rehabilitation exercise ergometer 100 according to an embodiment of the present disclosure is a rehabilitation bicycle that enables multiple track exercises, and may include a flywheel 110, a plane-of-rotation adjustment part 120, a crank arm 130, and a pedal part 140.

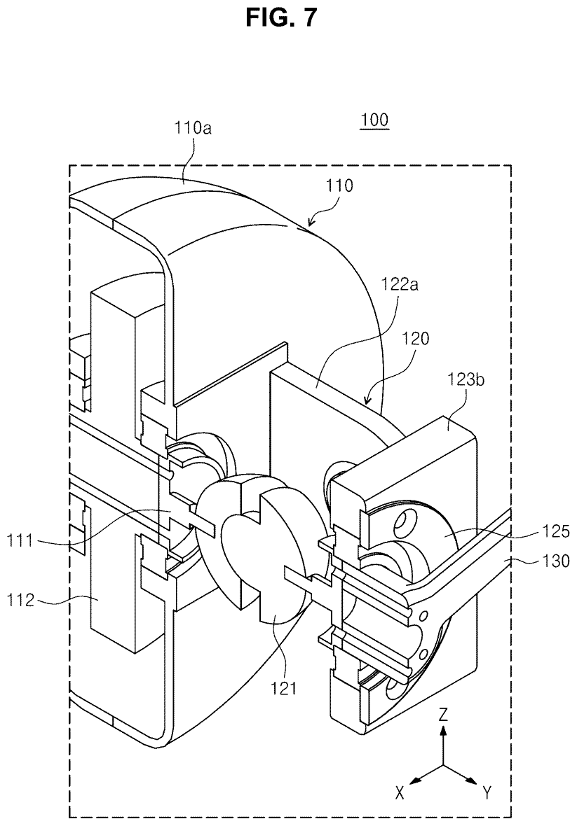

The flywheel 110 may include a flywheel body 112 (see FIG. 7) that is installed in an inner space of the bicycle ergometer body 110a to be rotatable by a supporting means, such as a bearing 111. The bicycle ergometer body 110a may be installed to be firmly fixed to a mobile support for rehabilitation on a floor or a bed by a support (not illustrated) in a space, such as a hospital, a rehabilitation institution, a gym, or a house so that a rehabilitation exercise rehabilitation patient may perform rehabilitation exercise. A saddle, on which a rehabilitation patient may sit, may be provided on an upper side of the bicycle ergometer body 110a.

The plane-of-rotation adjustment parts 120 may be provided at opposite sides of the flywheel 110, respectively. The plane-of-rotation adjustment part 120 may be configured to tilt the pedal track of the pedal part 140 by adjusting a deflection angle of a rotational axis of the plane of rotation, on which the crank arm 130 is rotated. The crank arm 130 is coupled to be rotatable by a bearing 125 (see FIG. 7) that is provided on a side plate 123b of the plane-of-rotation adjustment part 120.

The crank arm 130 may be coupled to transmit rotational power to the flywheel 110. The crank arm 130 may be configured to include a crank arm body 131 that is coupled to the side plate 123b of an adjustment member 122b to be rotatable and extends toward the pedal part 140, a first coupling part 132 that is provided at one end of the crank arm body 131 to couple the crank arm body 131 to the side plate 123b of the adjustment member 122b such that the crank arm body 131 is rotatable, and a second coupling part 133 that is provided at an opposite end of the crank arm body 131 to couple the crank arm body 131 to the pedal part 140.

The pedal part 140 is connected to an end portion of the crank arm 130 to direct contact a foot part of the user. Accordingly, when a user, who is a rehabilitation patient, steps on the pedal part 140 through the foot part, the crank arm 130 is rotated, and the rotational power of the crank arm 130 is transmitted to the flywheel 110 to rotate the flywheel 110. Through this, it is possible to perform a rehabilitation exercise in the form, in which the rehabilitation patient rides on a bicycle.

The plane-of-rotation adjustment part 120 may be configured to switch the pedal track of the pedal part 140 between a plurality of planes of rotation with different defection angles of rotational axes. Here, the plurality of planes of rotation include a sagittal plane of rotation, in which the deflection angle of the rotation axis is parallel to a horizontal direction, a plane of internal rotation, in which the deflection angle of the rotation axis is tilted in a first direction with respect to the sagittal plane, and a plane of external rotation, in which the deflection angle of the rotational axis is tilted in a second direction being opposite to the first direction with respect to the sagittal plane.

The sagittal plane of rotation is a plane of rotation corresponding to a pedal track of a generally known conventional ergometer. The plane of internal rotation may mean a plane of rotation that is inclined such that an uppermost part of the pedal track faces the flywheel and a lowermost part of the pedal track becomes more distant from the flywheel. Unlike this, the plane of external rotation is a plane of rotation that is inclined in an opposite direction to the plane of internal rotation, and may mean a plane of rotation that is inclined such that an uppermost part of the pedal track becomes more distant from the flywheel and a lowermost part of the pedal track faces the flywheel.

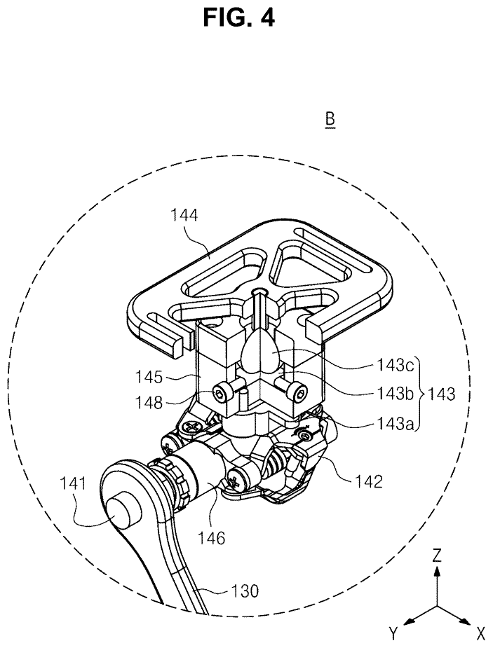

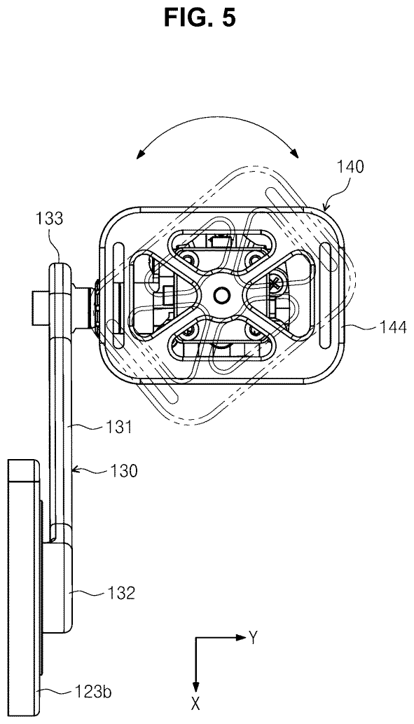

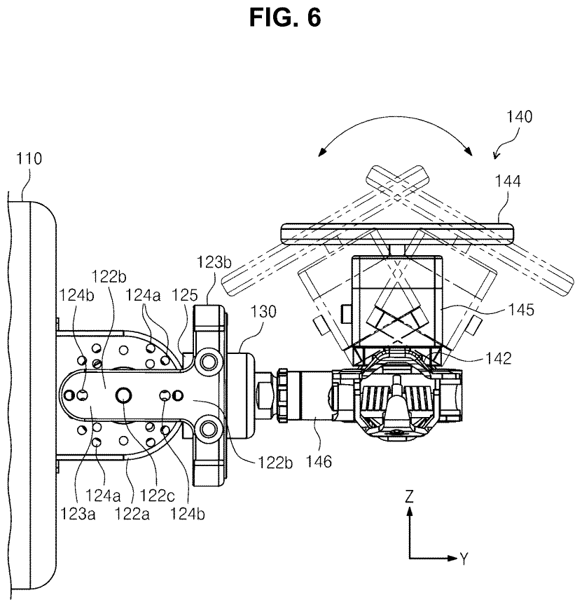

A detailed structure of the plane-of-rotation adjustment part will be described later, and a configuration of the pedal part 140 will be described first. FIG. 4 is an enlarged perspective view illustrating portion ‘B’ of FIG. 1. FIG. 5 is a plan view illustrating an operation of a pedal part that constitutes a rehabilitation exercise ergometer according to an embodiment of the present disclosure. FIG. 6 is a side view illustrating an operation of a pedal part that constitutes a rehabilitation exercise ergometer according to an embodiment of the present disclosure.

The pedal part 140 may be provided at an end of the crank arm 130, and may be configured to freely adjust a relative rotation (a leftward/rightward rotation on a plane corresponding to the pedal footplate) and/or a tilt angle (a leftward/rightward rotation when viewed from a front side) of the foot part of the rehabilitation exercise rehabilitation patient. To this end, the pedal part 140 may be configured to include a pedal shaft 141, a joint fixing part 142, a pedal joint part 143, and a pedal footplate 144.

The pedal shaft 141 is coupled to an end of the crank arm 130 to be rotatable in a direction that is perpendicular to the crank arm 130, and may be configured to be rotated freely through a supporting means, such as a bearing. The joint fixing part 142 may be configured to fix the pedal joint part 143 to the coupling part 146 provided in the pedal shaft 141.

The joint fixing part 142 may be configured in a cleat structure as an example to fix the pedal joint part 143 to the pedal shaft 141. In addition, the joint fixing part 142 may be formed of various means, such as a bolt/nut coupling structure and a clamp structure, and may be used without particular limitation as long as it may function to fix the pedal joint part 143 to the pedal shaft 141. The joint fixing part 142 may be configured to allow the user to easily remove or mount the equipment before and after an exercise, or to move the equipment in an emergency.

The pedal joint part 143 is connected to the pedal shaft 141 by the joint fixing part 142. The pedal joint part 143 may be configured to be freely rotatable in a transverse axis direction (rotation in a leftward/rightward direction when viewed from a front side as illustrated in FIG. 6) and/or a vertical axis direction (rotation on a plane viewed from a top as illustrated in FIG. 5).

The pedal joint part 143 is configured to variously adjust relative locations and directions (internal/external rotation, internal rotation/external rotation, and the like) of the foot part of the user with respect to the pedal shaft 141. The pedal footplate 144 is configured such that a relative angle to the pedal shaft 141 is adjustable by the pedal joint part 143, and is configured to directly contact the foot part of the rehabilitation patient.

In the embodiment of the present disclosure, the pedal joint part 143 may be configured in the form of a ball joint 143c as an example to enable rotation in the transverse axis and the vertical axis. The ball joint 143c is a part that adjust the relative angle (the longitudinal axis and the vertical axis) with respect to the pedal shaft 141, and transmits the rotational force in a fixed connection state, and may include a ball joint mount holder 143b that is mounted in a body 145 of the pedal joint part 143 by fixing bolts 143a and 148. The ball joint mount holder 143b may contact a normal plane provided in an interior of the body 145 of the pedal joint part 143.

The fixing bolts 143a and 148 may be coupled through a bolt coupling hole that is provided in the body of the pedal joint part 143. The user may provide a fastening force to the pedal footplate 144 by the ball joint mount holder 143b by fastening the fixing bolts 143a and 148 and raising the ball joint mount holder 143b along a normal plane in an interior of the body 145 of the pedal joint part 143, to adjust a location of the ball joint 143c after locating the pedal footplate 144 at a desired position of the foot part.

FIG. 7 is a cutaway perspective view illustrating a main part of a rehabilitation exercise ergometer according to an embodiment of the present disclosure. Hereafter, referring to FIGS. 1 to 3 and 7, a detailed structure of the plane-of-rotation adjustment part 120 will be described in detail. In an embodiment of the present disclosure, the plane-of-rotation adjustment part 120 may include a shaft seam 121 and a shaft fixing part 122.

The shaft seam 121 fastens one end of the crank arm 130 and the flywheel 110 so that the crank arm 130 is rotated at the same speed even when a direction of the plane of rotation of the crank arm 130 with respect to the plane of rotation of the flywheel 110 is switched. The shaft seam 121 of the plane-of-rotation adjustment part 120 may serve to fasten the power shafts of the flywheel 110 and the crank arm 130 while the rotary shafts are converted to rotate the flywheel 110 and the crank arm 130 in the same way.

The shaft seam 121 of the plane-of-rotation adjustment part 120 may be a constant-speed joint, such as a zeppa universal joint or a bell type joint, or a universal joint. Because the shaft seam 121 may be implemented as a known shaft seam device that connects two rotary shafts in an angle-adjustable manner to transmit power, a detailed description thereof will be omitted.

The shaft fixing part 122 serves to fix the power shaft of the flywheel 110 and the power shaft of the crank arm 130 such that they may be rotated while a constant deflection angle is maintained, and to fix the deflection angle of the rotational axis of the crank arm 130 after it is adjusted. The shaft fixing part 122 is configured to apply a tilt angle to the plane of rotation of the crank arm 130 with respect to the plane of rotation of the flywheel 110, and to fix the tilt angle while it is maintained.

According to an embodiment of the present disclosure, the shaft fixing part may include a central member 122a that is fixed to a body supporting the flywheel 110, an adjustment member 122b that is coupled to an end of the crank arm 130 to be rotatable about an angle adjustment axis 122c, and a fixing member that couples the central member 122a and the adjustment member 122b.

The central member includes a plurality of first coupling holes 124a that are punched at every specific angle with respect to the angle adjustment axis 122c, and form an arc-shaped arrangement. A pair of central members 122a may be provided on opposite sides with respect to the shaft seam 121 to be stably coupled to the adjustment member 122b.

The adjustment member 122b may be configured to include a pair of fixing plates 123a that are coupled to the pair of central members 122a by fixing members, respectively, and a side plate 123b that connects the pair of fixing plates 123a. The fixing plate 123a of the adjustment member 122b may include a second coupling hole 124b at a position corresponding to the first coupling hole 124a of the central member 122a.

The fixing member may be inserted into at least one of the plurality of first coupling holes 124a provided in the central member 122a, and the second coupling hole 124b provided in the adjustment member 122b to fix the central member 122a and the adjustment member 122b. The fixing member may be formed of a ball lock pin that is coupled to any one of a plurality of holes that are punched at every specific angle, and may be configured to fix the deflection angle of the rotational axis of the crank arm 130 at a desired angle.

In this way, the rehabilitation exercise ergometer 100 according to an embodiment of the present disclosure may adjust a rotation exercise track for a rehabilitation exercise of the rehabilitation patient by applying various tilt angles between the plane of rotation of the flywheel 110 and the planes of rotation of the crank arm 130 and the pedal part by the plane-of-rotation adjustment part 120.

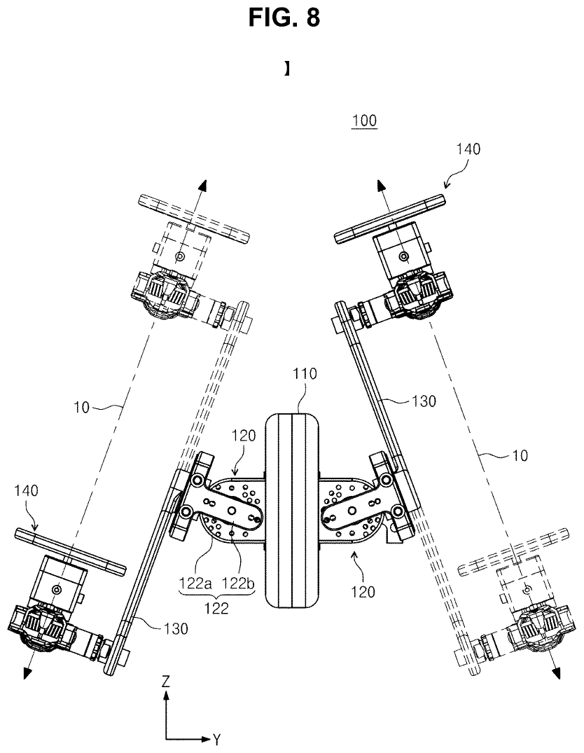

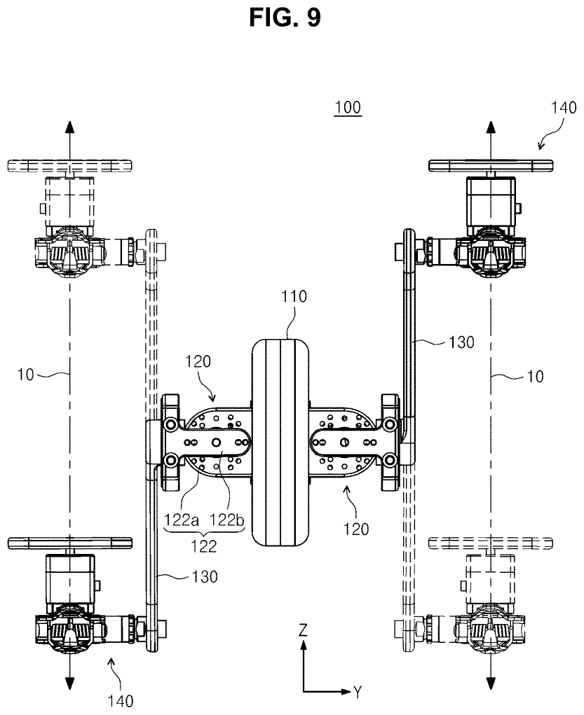

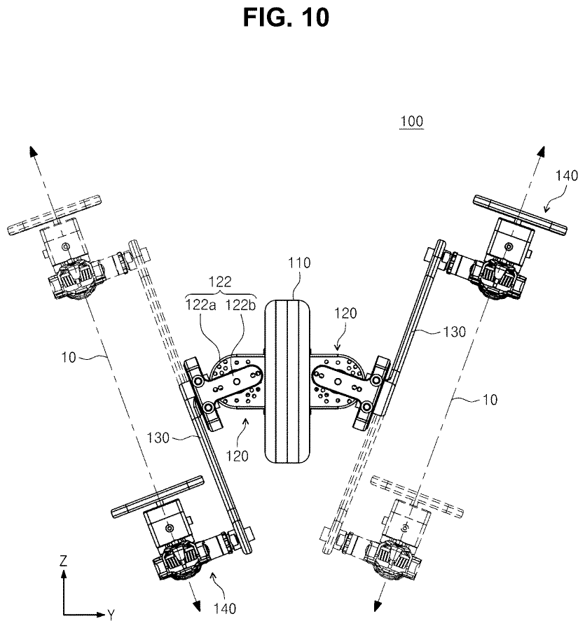

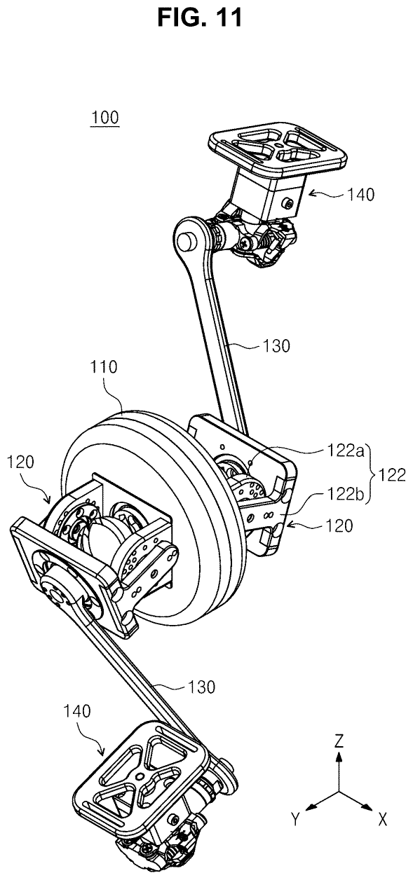

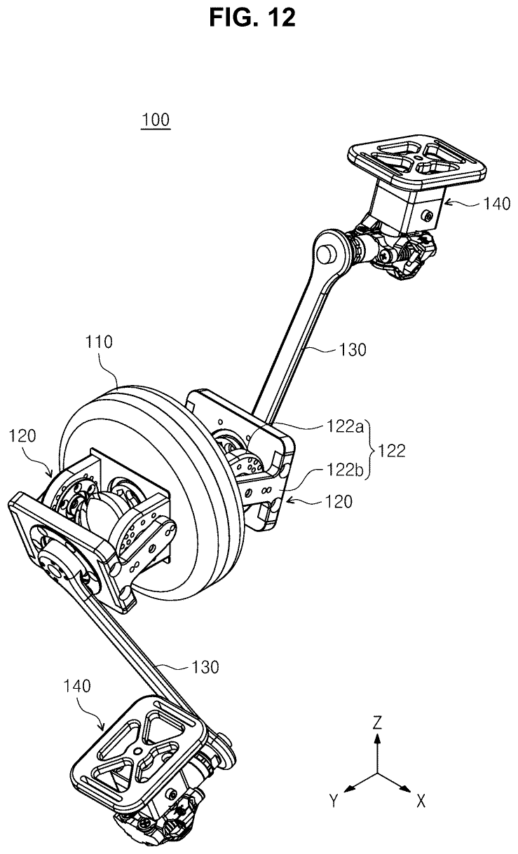

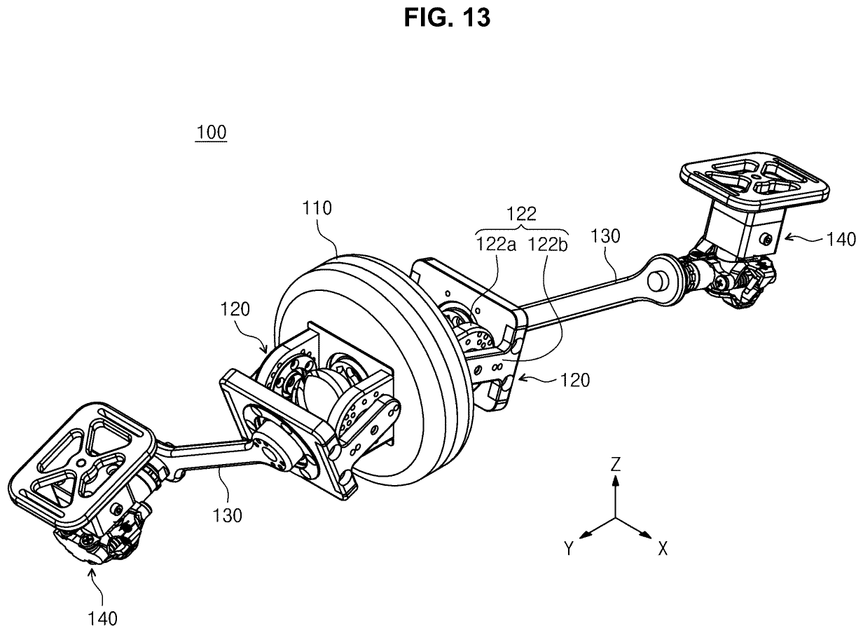

FIGS. 8 to 10 are front views illustrating an operation of a rehabilitation exercise ergometer according to an embodiment of the present disclosure. FIGS. 11 to 13 are perspective views illustrating an operation of a rehabilitation exercise ergometer according to an embodiment of the present disclosure. FIGS. 8 to 13 illustrate the movement of a crank arm that is rotated on a variously displaced plane of rotation when a rehabilitation exercise is performed.

Referring to FIGS. 8 to 13, the plane-of-rotation adjustment part 120 may adjust the deflection angle of the rotational axis of the plane of rotation with respect to the plane of rotation of the flywheel 110. Through this, internal and external rotation tracks may be formed for the plane of rotation of the crank arm 130, and power can be transmitted to the flywheel 110 while the rotation track of the footplate is maintained on the plane of rotation when the crank arm 130 is rotated through the shaft seam 121 and the shaft fixing part 122 of the plane-of-rotation adjustment part 120.

In a state, in which the plane of rotation is adjusted, the crank arm 130 is rotated when the user steps on the pedal part 140 for rotation, and a rotational angular speed of the crank arm 130 is transmitted to the constant-speed joint (the shaft seam), and power is transmitted to the flywheel 110 directly fastened to the constant-speed joint. Through this, a series of processes of transmitting power to the opposite crank arm 130 having an opposite phase are performed.

Meanwhile, in the above-described embodiment, a manner of fastening the fixing member, such as a ball lock pin, to the first coupling hole 124a and the second coupling hole 124b and tilting the rotation track of the pedal part 140 in a state, in which the positions of the first coupling hole 124a provided in the central member 122a and the second coupling hole 124b provided in the adjustment member 122b are aligned has been described as an example, but the present disclosure is not limited thereto, and the rotation track of the pedal part 140 may be tilted at various angles by rotating the adjustment member 122b with respect to the central member 122a by various types of drivers, such as a driving cylinder, a driving motor, a driving belt, and a screw-shaft coupler.

Meanwhile, as described above, the pedal part 140 additionally has a degree of freedom of rotation in a transverse axis (the y axis or the x axis) and a vertical axis (the z axis) through adjustment of the pedal joint part to enable rolling and yawing when the pedal shaft is viewed in the longitudinal axis (the x axis or the y axis), and through this, the user may perform a rehabilitation exercise while taking various foot postures, such as an internal rotation, an external rotation, and internal and external rotation postures. In this way, due to the change in the posture through adjustment of the pedal, a muscle pattern that is activated during performance of the exercise may be changed, and a direction of a load applied to the joint may be adjusted.

According to an embodiment of the present disclosure, during a rehabilitation exercise utilizing an ergometer of a bicycle, exercise tracks and various foot postures may be adjusted (internal/external rotation, or internal rotation/external rotation) on multiple planes by allowing the pedal track to be tilted in an arbitrary direction while deviating from a structure that is limited only to an existing single plane, that is, the sagittal plane.

According to the rehabilitation exercise ergometer according to an embodiment of the present disclosure as described above, an individual user may perform effective training by focusing on the muscles and functions they want to train, and the stability of the exercise, such as relief of pain and protection of a surgical portion, may be increased by switching the direction of the external force applied to the joint.

In particular, it is not limited to the sagittal plane, which is the track of rehabilitation exercise, but rotational and coronal plane movements are variably controlled, so that the muscle strength and functions that may be trained for rehabilitation may be diversified, and various problems, such as arthritis, due to the relative positions of the ankle and the knee may be prevented.

As described above, according to the present disclosure, the effectiveness and stability of customized rehabilitation for rehabilitation patients in clinical settings may be maximized through diversification of exercise tracks and an increase in the degree of freedom of the exercise of the rehabilitation patient. Because the rehabilitation exercise ergometer according to an embodiment of the present disclosure utilizes the form of a bicycle ergometer, it acts in a form that allows training of an affected side by utilizing the power of the subject's own healthy side in the case of a non-powered form, and may be distributed at low costs without an expensive drive system. In addition, it is not limited to use as a rehabilitation training device, but may also be applied to personal training bicycles, so that it may be developed into a form that allows exercises and training while stimulating the target muscles.

The present disclosure is based on a series of processes, in which a specialist who instructs and supervises rehabilitation exercises directly analyzes rehabilitation patient information and selects rehabilitation goals and tracks, but an automated process, in which a pedal track selection algorithm is configured based on rehabilitation patient data and target exercise part information to select and recommend an appropriate exercise trajectory, may be introduced. Additionally, rehabilitation exercises may be adjusted by re-reflecting the various measured information through a feedback process. To this end, the measurement sensor may include various sensors, such as force and inertial sensors.

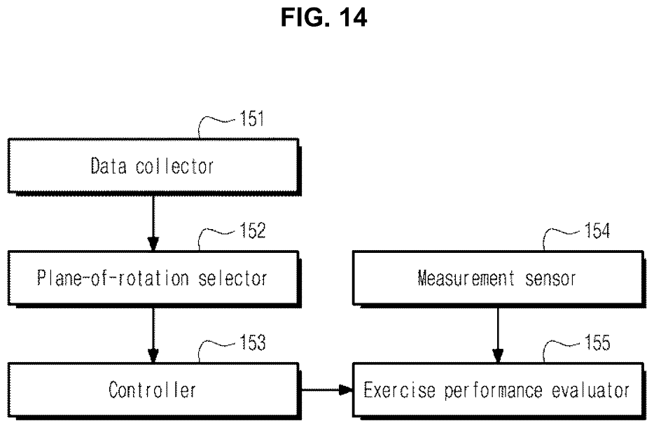

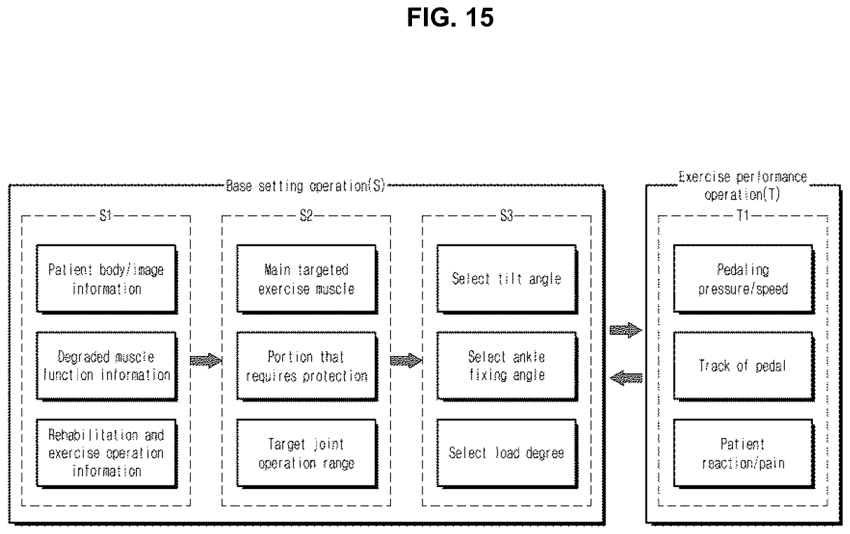

FIG. 14 is a schematic diagram of a rehabilitation exercise ergometer according to an embodiment of the present disclosure. FIG. 15 is a conceptual view illustrating a function of a rehabilitation exercise ergometer according to an embodiment of the present disclosure. Referring to FIGS. 14 and 15, the rehabilitation exercise ergometer according to an embodiment of the present disclosure may further include a data collector 151, a plane-of-rotation selector 152, a controller 153, a measurement sensor 154, and an exercise performance evaluator 155.

The data collector 151 may collect rehabilitation patient information including image information (X-ray, MRI, a CT image) and body function information related to the rehabilitation patient, and rehabilitation related information, in a base setting operation “S” performed in a previous operation of an exercise performance operation “T” (S1). The rehabilitation patient information (for example, an age, a gender, a pain level, possible aftereffects, and the like), including physical function information (muscle function information) and rehabilitation related information (rehabilitation and exercise stage information) may be collected through a doctor's interview, diagnosis results, and a questionnaire on the rehabilitation patient and may be stored in a database.

The plane-of-rotation selector 152 may determine a target plane of rotation for a rehabilitation exercise of the rehabilitation patient based on the rehabilitation patient information collected by the data collector 151 (S2 and S3). The plane-of-rotation selector 152 may analyze the main target exercise muscle, a portion that needs protection, and the target joint operation range, based on the rehabilitation state, doctor interview information, questionnaire information, and the like extracted from the image information (S2), and may calculate the tilt angle, an ankle fixation angle, and a load degree of the pedal track, which are suitable for the rehabilitation patient through the analysis results (S3).

As an embodiment, the plane-of-rotation selector 152 may extract features (feature maps) of the rehabilitation portion through convolution processing using kernel images from the medical image, which is input data, based on the learned convolution artificial neural network, and may output an appropriate tilt angle of the pedal track. The convolutional artificial neural network may be learned based on learning data including medical images for each rehabilitation patient, rehabilitation patient information, and tilt angles recommended for each rehabilitation patient by a doctor. When each item of the rehabilitation patient information is input to the input nodes of the fully connected layer along with the features extracted by the convolutional artificial neural network, an appropriate tilt angle value may be output through the output node through a plurality of hidden layers.

The controller 153 may control the plane-of-rotation adjustment part 120 depending on the target plane of rotation determined by the plane-of-rotation selector 152 to adjust the plane of rotation and the deflection angle of the rotational axis of the crank arm 130. The controller 153 may control a driver, such as a drive cylinder, depending on a target plane of rotation to drive the plane-of-rotation adjustment part 120, thereby adjusting the tilt angle of the pedal track to a recommended angle for the rehabilitation patient. Alternatively, the controller 153 may be provided as a means for outputting an appropriate tilt angle of the pedal track to the user so that the user may directly adjust the angle of the pedal track by manipulating the plane-of-rotation adjustment part 120.

The measurement sensor 154 is configured to collect exercise information and bio-signals related to rehabilitation of the rehabilitation patient while the rehabilitation patient performs an exercise by using a rehabilitation exercise ergometer 100. The measurement sensor 154 may include, for example, an exercise measurement sensor (for example, a force sensor, an inertia sensor, and the like) for measuring a force and/or an inertia generated by the rehabilitation excise, and one or more sensors (for example, a temperature sensor, a respiration sensor, a pulse sensor, a blood pressure sensor, and the like) for collecting various bio-signals, such as a temperature, a respiration, a pulse, and a blood pressure of the rehabilitation patient.

The exercise performance evaluator 155 may evaluate the exercise performance of the rehabilitation patient according to the plane of rotation during the rehabilitation exercise of the rehabilitation patient based on the bio-signals of the rehabilitation patient collected by a measurement sensor T1. The exercise performance evaluator 155 may compare the bio-signals collected by the measurement sensor 154 with the reference bio-signal level set to suit the rehabilitation patient to determine whether the rehabilitation patient is obtaining an appropriate level of rehabilitation exercise effect.

When it is determined by the exercise performance evaluator 155 that the tilt angle of the pedal track may obtain an appropriate rehabilitation exercise effect for the rehabilitation patient, a positive feedback may be generated and the artificial neural network may be learned, and to the contrary, when it is determined that the tilt angle of the pedal track does not provide an appropriate rehabilitation exercise effect to the rehabilitation patient, a negative feedback may be generated and the artificial neural network may be learned. In this way, by continuously learning the artificial neural network, the accuracy of predicting the appropriate tilt angle of the pedal track may be improved.

For example, the exercise performance evaluator 155 may evaluate an appropriateness of the rehabilitation exercise based on a pedaling pressure/speed, a pedal track, a rehabilitation patient response/pain during a rehabilitation exercise of the rehabilitation patient, and may update the algorithm or parameter in the base setting stage “S” while reflecting the evaluation results.

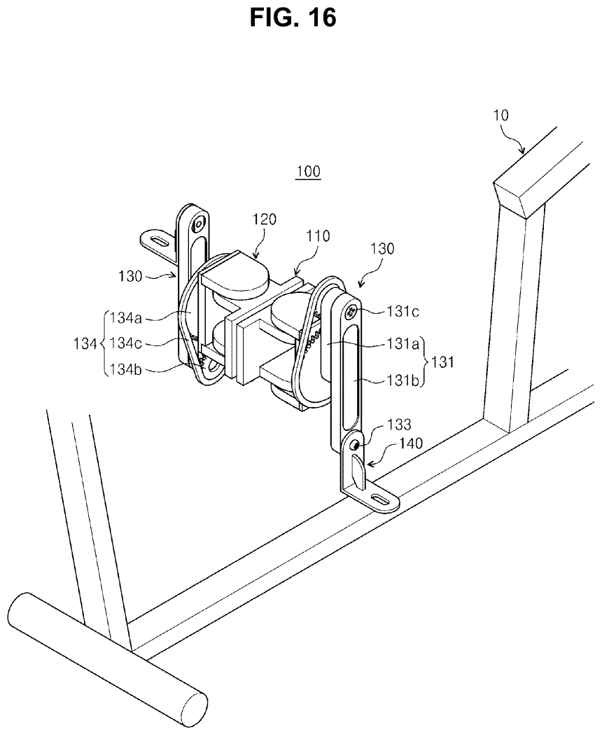

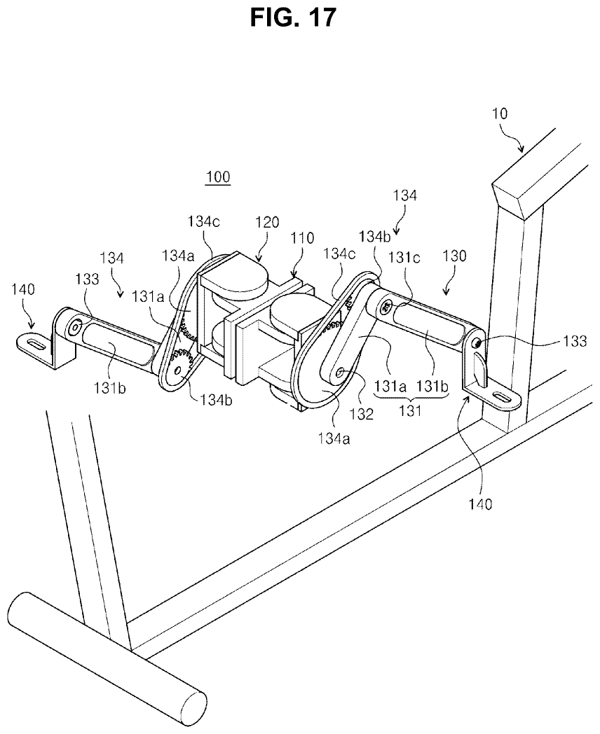

FIG. 16 is a perspective view illustrating a rehabilitation exercise ergometer according to another embodiment of the present disclosure. FIG. 17 is a perspective view illustrating an operation of a rehabilitation exercise ergometer according to an embodiment of FIG. 16. The rehabilitation exercise ergometer 100 according to the embodiment of FIGS. 16 and 17 differs from the previously described embodiment in that it further includes a rotation track adjusting device that transforms the rotation track into an elliptical shape. Because the configuration of the flywheel or the plane-of-rotation adjustment part installed on a support 10 has been described above, any repeated description will be omitted. The rotation track adjusting device may change the rotational track of the pedal part 140 from a circular shape to an elliptical shape.

The length of the crank arm 130 may be adjusted depending on the rotation cycle by a rotation track adjusting device, or the rotation track of the pedal part 140 may be transformed into an elliptical shape through various methods, such as a link-gear mechanism or a sliding mechanism. Through this, the effectiveness of rehabilitation may be increased by expanding/diversifying the subject's joint range of motion, compared to the circular rotation method.

In an embodiment, the rotation track adjusting device may include a crank arm length adjusting device 134 that adjusts the length of the crank arm body 131 depending on the rotation cycle. The crank arm body 131 may include a first crank arm body 131a, one end of which is coupled to the plane-of-rotation adjustment part 120 such that the deflection angle may be adjusted, and a second crank arm body 131b that is coupled to an opposite end of the first crank arm body 131a to be rotatable by a rotary shaft 131c provided at one end thereof. The pedal part 140 may be coupled to an opposite end of the second crank arm body 131b to be rotatable by the second coupling part 133.

The crank arm length adjusting device 134 may be configured to include a first gear member 134a that is coupled to one end of the first crank arm body 131a, a second gear member 134b that has a diameter that is smaller than that of the first gear member 134a and is coupled to the second crank arm body 131b at an opposite end of the first crank arm body 131a, and a ring-shaped belt member 134c that is coupled to the first gear member 134a and the second gear member 134b. The belt member 134c may be provided with gear grooves that are engaged with the teeth of the first gear member 134a and the second gear member 134b.

By the crank arm length adjusting device 134, the crank arm 130 may be rotated in an elliptical rotation track, of which an upward/downward width is twice the length of the first crank arm body 131a and of which leftward/rightward width is twice the total length of the first crank arm body 131a and the second crank arm body 131b. To this end, the crank arm length adjusting device 134 may be designed such that the second crank arm body 131b is disposed in an upward/downward direction to overlap the first crank arm body 131a when the first crank arm body 131a is disposed in the upward/downward direction, and the second crank arm body 131b is disposed to be spread out in parallel to an outside of the first crank arm body 131a when the first crank arm body 131a is disposed in a horizontal direction.

While embodiments have been shown and described with reference to the accompanying drawings, it will be apparent to those skilled in the art that various modifications and variations may be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents. Therefore, other implements, other embodiments, and equivalents to claims are within the scope of the following claims.

1. A rehabilitation exercise ergometer comprising:
a flywheel provided in an ergometer of a bicycle to be rotatable;
plane-of-rotation adjustment parts provided on opposite sides of the flywheel, respectively;
crank arms coupled to the plane-of-rotation adjustment parts to be rotatable; and
pedal parts provided at ends of the crank arms,
wherein the plane-of-rotation adjustment part is configured to tilt a pedal track of the pedal part by adjusting a deflection angle of a rotation axis of a plane of rotation, on which the crank arm is rotated.

2. The rehabilitation exercise ergometer of claim 1, wherein the plane-of-rotation adjustment part is configured to switch the pedal track between a plurality of planes of rotation, in which the deflection angles of the rotational axis are different.

3. The rehabilitation exercise ergometer of claim 2, wherein the plurality of planes of rotation include a sagittal plane of rotation, in which the deflection angle of the rotation axis is parallel to a horizontal direction, a plane of internal rotation, in which the deflection angle of the rotation axis is tilted in a first direction with respect to the sagittal plane, and a plane of external rotation, in which the deflection angle of the rotational axis is tilted in a second direction being opposite to the first direction with respect to the sagittal plane.

4. The rehabilitation exercise ergometer of claim 1, wherein the plane-of-rotation adjustment part includes:
a shaft seam connecting one end of the crank arm and the flywheel such that rotation of the crank arm is maintained at the same speed even when the plane of rotation of the crank arm is switched; and
a shaft fixing part configured to fix the crank arm in a state, a tilt angle is applied to the plane of rotation of the crank arm with respect to the plane of rotation of the flywheel.

5. The rehabilitation exercise ergometer of claim 4, wherein the shaft fixing part includes:
a central member fixed to a body supporting the flywheel;
an adjustment member coupled to an end of the crank arm to be rotatable about an angle adjustment axis; and
a fixing member coupling the central member and the adjustment member,
wherein the central member includes a plurality of first coupling holes punched at every specific angle with respect to the angle adjustment axis, and forming an arc-shaped arrangement,
wherein the adjustment member includes a second coupling hole at a position corresponding to the first coupling hole, and
wherein the fixing member includes a ball lock pin inserted into at least one of the plurality of first coupling holes and the second coupling hole to fix the central member and the adjustment member.

6. The rehabilitation exercise ergometer of claim 1, wherein the pedal part includes:
a pedal shaft coupled to an end of the crank arm to be rotatable in a direction being perpendicular to the crank arm;
a pedal joint part connected to the pedal shaft by the joint fixing part, and configured to be rotatable in transverse axis and vertical axis directions; and
a pedal footplate configured such that a relative angle to the pedal shaft is adjusted by the pedal joint part.

7. The rehabilitation exercise ergometer of claim 6, wherein the pedal joint part includes a ball joint provided in the pedal joint body, and
wherein the ball joint adjusts the relative angle to the pedal shaft in the pedal joint body and transmits a rotational force.

8. The rehabilitation exercise ergometer of claim 4, wherein the shaft fixing part includes:
a central member fixed to a body supporting the flywheel; and
an adjustment member coupled to an end of the crank arm to be rotatable about an angle adjustment axis, and
wherein the rehabilitation exercise ergometer further includes a driver configured to rotate the adjustment member with respect to the central member to adjust a tilt angle of a rotation track of the pedal part.

9. The rehabilitation exercise ergometer of claim 8, further comprising:
a data collector configured to collect rehabilitation patient information including image information and body function information related to a rehabilitation patient, and rehabilitation-related information;
a plane-of-rotation selector configured to determine a target plane of rotation for a rehabilitation exercise of the rehabilitation patient based on the rehabilitation patient information; and
a controller configured to adjust the plane of rotation by controlling the driver depending on the target plane of rotation.

10. The rehabilitation exercise ergometer of claim 9, further comprising:
a measurement sensor configured to collect exercise information and biometric information related to the rehabilitation exercise of the rehabilitation patient during an exercise of the rehabilitation patient by the rehabilitation exercise ergometer; and
an exercise performance evaluator configured to evaluate performance of the exercise of the rehabilitation patient depending on the plane of rotation based on the exercise information and the biometric information of the rehabilitation patient.

11. The rehabilitation exercise ergometer of claim 1, further comprising:
a rotation track adjusting device configured to deform a rotation track, in which the pedal part is rotated by the crank arm, into an elliptical form.

12. The rehabilitation exercise ergometer of claim 11, wherein the crank arm includes a first crank arm body, and a second crank arm body coupled to the first crank arm body to be rotatable, and
wherein the rotation track adjusting device includes a crank arm length adjusting device configured to adjust a length of the crank arm body depending on a rotation cycle.

13. The rehabilitation exercise ergometer of claim 12, wherein the crank arm length adjusting device includes a first gear member coupled to one end of the first crank arm body, a second gear member having a diameter being smaller than that of the first gear member, and coupled to the second crank arm body at an opposite end of the first crank arm body, and a ring-shaped belt member coupled to the first gear member and the second gear member.

14. The rehabilitation exercise ergometer of claim 13, wherein the crank arm length adjusting device is designed such that the second crank arm body is disposed in an upward/downward direction to overlap the first crank arm body when the first crank arm body is disposed in the upward/downward direction, and the second crank arm body is disposed to be spread out in parallel to an outside of the first crank arm body when the first crank arm body is disposed in a horizontal direction.
